(19) United States
(12) Patent Application Publication
(10) Pub. No.: US 2019/0063393 A1
(43) Pub. Date: Feb. 28, 2019

(54) WARM UP SYSTEM FOR AN ENGINE OF A MACHINE

(71) Applicant: Progress RailServices Corporation, Albertville, AL (US)

(72) Inventors: Andrew Smith, Peoria, IL (US); John F. Kral, Plainfield, IL (US); Stephen Boucher, Woodridge, IL (US)

(73) Assignee: Progress Rail Services Corporation, Albertville, AL (US)

(21) Appl. No.: 15/684,344

(22) Filed: Aug. 23, 2017

(51) Int. Cl. F02N 19/10; F02N 11/04; F01P 3/20; F01P 7/16; B61C 17/00; B61C 5/00; B61K 9/00

(52) U.S. Cl. CPC F02N 19/10; F02N 11/04; F01P 3/20; F01P 7/16; F01P 2060/18; B61C 5/00; B61K 9/00; F02N 2200/02; F01P 2025/08; B61C 17/00

(57) ABSTRACT

A warm-up system for an engine of a machine is provided. The machine has a primary alternator and an auxiliary alternator. The warm-up system includes at least one coolant heater configured to heat a coolant flowing through one or more coolant passages of the engine. The coolant heater is electrically powered by the auxiliary alternator of the machine when the engine runs at low load or idle conditions. The engine warm-up system further includes a thermostatic device operably coupled to the coolant heater and configured to control the operation of the coolant heater based on a temperature of the coolant flowing through the coolant passages.

### TECHNICAL FIELD

The present disclosure relates to an engine of a machine. More particularly, the present disclosure relates to a system and method for warming up the engine of the machine.

### BACKGROUND

Many machines, such as locomotives, employ engines that combust fuels to generate mechanical and/or electrical power for propelling the locomotive and powering its various support and control systems. However, in cold ambient temperatures, these engines may take considerable amount of time to get heated up to a minimum operational temperature. Operating the machine in such cold weather therefore becomes very difficult.

One way to mitigate this problem is through use of a coolant heater positioned in connection with an engine cooling system. Such coolant heater beats up a coolant flowing through one or more coolant passages of the engine, which in turn heats up the engine to the minimum operational temperature in a lesser amount of time. Occasionally, yards, where these locomotives are parked, have electrical, power receptacles to which these coolant heaters may be connected to receive power and heat the coolant flowing through the one or more coolant passages of the engine. However, in such implementations, the coolant heater shall be disconnected from the electrical power receptacles before starting the egine the engine of the locomotive for operation, which is undesirable. More often, yards where these locomotives are stabled do not have electrical power receptacles available for the connection of locomotive coolant heater systems.

### SUMMARY

In one aspect, a warm-up system for an engine of a machine is provided. The machine has a primary alternator and an auxiliary alternator. The warm-up system includes at least one coolant heater configured to heat a coolant flowing through one or more coolant passages of the engine. The coolant heater is electrically powered by the auxiliary alternator of the machine when the engine runs at low load or idle conditions. The engine warm-up system further includes a thermostatic device operably coupled to the coolant heater and configured to control, the operation of the coolant heater based on a temperature of the coolant flowing through the coolant passages.

In another aspect of the present disclosure, a method for warming up an engine of a machine is provided. The machine includes a primary alternator and an auxiliary alternator. The method includes measuring a temperature of a coolant flowing through one or more coolant passages of the engine. The method further includes operating at least one coolant heater to heat the coolant flowing through the one or more coolant passages of the engine based on the measured temperature of the coolant. The coolant heater is electrically powered by the auxiliary alternator of the machine when the engine operates at low load or idle conditions.

In a yet another aspect of the present disclosure, a machine is provided. The machine includes an engine having one or more coolant passages defined therein. The machine further includes a primary alternator and an auxiliary alternator. The primary alternator is driven by the engine and is configured to power large power loads of the machine. The auxiliary alternator is driven by the primary alternator and is configured to power auxiliary loads of the machine. The machine further includes an engine cooling system configured to circulate a coolant through the coolant passages of the engine. At least one coolant heater is also operably connected to the engine cooling system and is configured to heat the coolant flowing through one or more coolant passages of the engine. The coolant heater is electrically powered by the auxiliary alternator of the machine when the engine operates in low load or idle conditions. Furthermore, the machine includes a thermostatic device operably coupled to the engine cooling system and the coolant heater. The thermostatic device is configured to operate the coolant heater to heat the coolant flowing through the one or more coolant passages of the engine based on a temperature of the coolant flowing through the coolant passages.

### BRIEF DESCRIPTION OF DRAWINGS

FIG. 1 illustrates an exemplary machine, in accordance with an embodiment of the present disclosure;

FIG. 2 illustrates a schematic representation of an engine cooling system having an engine warm-up system, in accordance with an embodiment of the present disclosure;

FIG. 3 illustrates a schematic representation of an engine cooling system having an engine warm-up system, in accordance with an alternative embodiment of the present disclosure;

FIG. 4 illustrates an exemplary method for warming up an engine, in accordance with an embodiment of the present disclosure; and

FIG. 5 illustrates an exemplary method for warming up an engine, in accordance with an alternative embodiment of the present disclosure;

### DETAILED DESCRIPTION

Reference will now be made in detail to embodiments of the present disclosure, examples of which are illustrated in the accompanying drawings. Wherever possible, the same reference numbers will be used throughout the drawings to refer to the same or like parts.

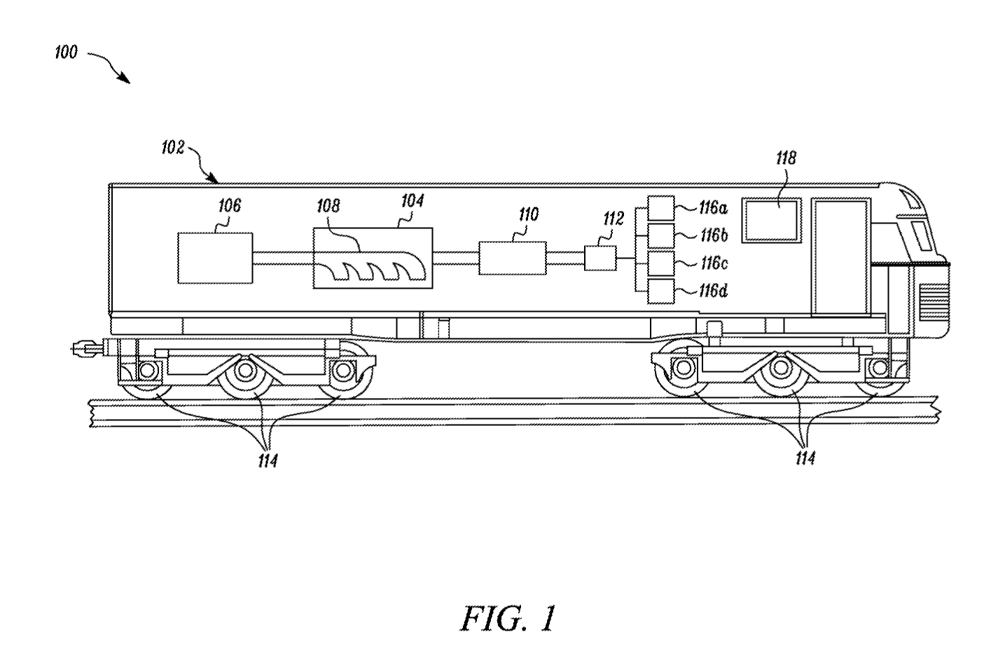

The present disclosure relates to a warm-up system for an engine of a machine. FIG. 1 illustrates an exemplary machine 100 according to an embodiment of the present disclosure. For the purposes of this disclosure, the machine 100 is depicted and described as a mobile machine such as a locomotive 102. The machine 100 may include an internal combustion engine 104 and an engine after treatment system 106 configured to receive combustion products, such as exhaust, from the engine 104.

The engine 104 may be based on one of the commonly applied power-generation units, such as an internal combustion engine (ICE), a fuel cell, etc. Further, the engine 104 configurations may include a V-type engine configuration, an in-line engine configuration, or the like, as known conventionally. The engine 104 may combust a fuel such as gasoline, diesel fuel, gaseous fuels, etc., and may generate a mechanical output and exhaust complex mixture of pollutants such as oxides of Nitrogen (NOx), particulate matter, carbon monoxide (CO) etc. These pollutants and other products of combustion may exit the engine 104 as hot exhaust gases via an exhaust manifold 108 connected to the exhaust ports of the engine 104 and pass through the after-treatment system 106, which reduces the pollutants from the exhaust, before reaching the atmosphere. The after-treatment system 106 may be a conventional after treatment system, and therefore the details of the after-treatment system 106 are not included in the description for the sake of brevity.

The engine 104 may be configured to combust the mixture of air and fuel to generate a mechanical output that drives one or more alternators, such as a primary alternator 110 and an auxiliary alternator 112. The primary alternator 110 may be driven by the engine 104 to provide power to one or more large loads of the machine 100. The auxiliary alternator 112 may be driven by the primary alternator 110 and configured to provide power to one or more auxiliary loads of the machine 100.

In an exemplary embodiment, the primary alternator 110 may be connected to and configured to provide power to one or more traction devices 114 of the machine 100. The traction devices 114 may include one or more devices configured to provide mechanical power to propel the machine 100. For example, the traction devices 114 may include one or more alternating current (AC) traction motors powered by the primary alternator 110. Alternatively, the traction devices 114 may also include direct current (DC) traction motors, if desired. When powered by the primary alternator 110, the traction devices 114 may drive wheels (e.g., adhesion rail, rack rail, etc.) to propel the machine 100. Although the traction devices 114 are depicted and described as wheels of the locomotive 102, it may be contemplated that the traction devices 114 may also include mechanical drive trains, crawler tracks or any other traction devices known in the art.

The auxiliary alternator 112 may be driven by the same means as the primary alternator 110 and configured to provide power to auxiliary loads of the machine 100. For example, the auxiliary alternator 112 may be configured to power one or more power consumption devices 116a, 116-b. 116-c, and 116-d thereinafter collectively referred to as the consumption devices 116). Such auxiliary power consumption devices 116 may include devices that support the operation of the machine 100, such as provide braking of traction devices 114, provide amenities to an operator cab 118, etc. In an embodiment of the present disclosure, the consumption devices 116 may include, but not limited to, compressed air system (e.g., including air compressors, dryers, conduits, valves, reservoirs, etc.), blowers, radiator fans, brake systems, interior and/or exterior lights, etc., which may be directly powered with current by the auxiliary alternator 112.

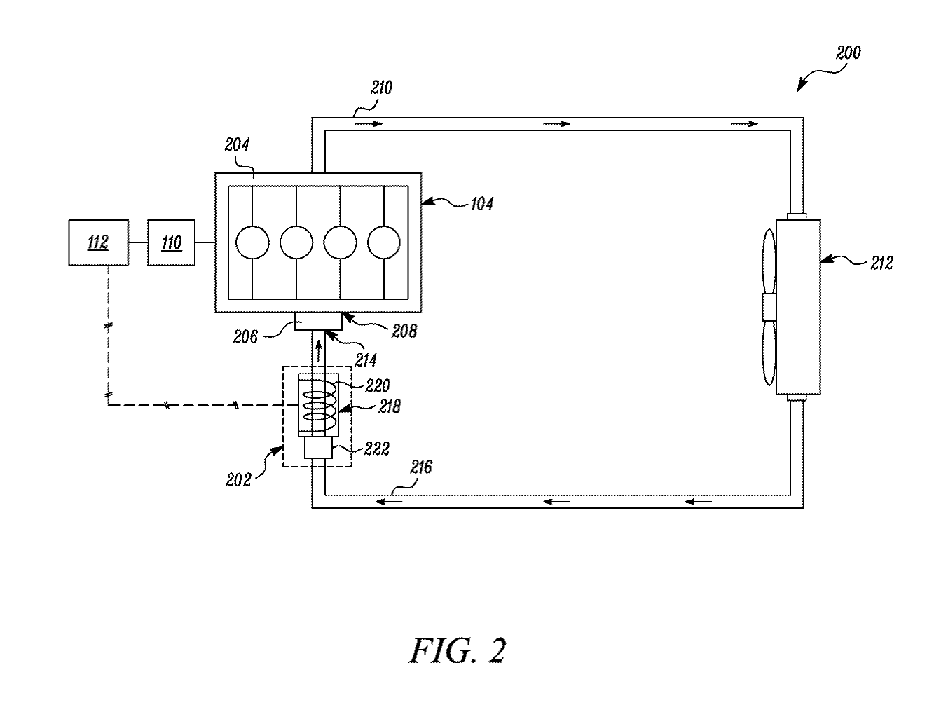

The machine 100 includes an engine cooling system 200 configured to cool down the engine 104 during operation. In an embodiment of the present disclosure, the machine 100 further includes an engine warm-up system 202 configured to warm-up the engine 104 in cold-weather conditions. The detailed working of the engine cooling system 200 and the engine warm-up system 202 is further depicted and described in conjunction to FIG. 2.

FIG. 2 illustrates an exemplary engine cooling system 200 and an engine warm-up system 202 of the machine 100. The engine cooling system 200 is configured to dissipate heat generated in the engine 104 during operation of the machine 100, by circulating a coolant around the engine 104. The engine 104 may include an engine cooling jacket having a number of coolant passages 204 to facilitate coolant flow to cool down the engine 104.

As illustrated in FIG. 2, the engine cooling system 200 includes a coolant pump 206 configured to circulate the coolant through the coolant passages 204 of the engine 104. A coolant pump outlet 208 is fluidly coupled to the coolant passages 204 and configured to facilitate flow of the coolant through the coolant passages 204 around the engine 104. The coolant exits from the engine 104 through an outlet conduit 210 positioned upstream of the engine 104 and is circulated through a radiator 212 which is configured to dissipate the heat from the coolant. The cooled coolant is then circulated back to the coolant pump 206, for recirculation, through a coolant pump inlet 214 via an inlet conduit 216.

It may be contemplated that in extremely cold weather conditions, the engine 104 may take considerable amount of time to get heated up to an operational temperature for operating the machine 100. Therefore, the engine warm-up system 202 is configured to heat the engine 104 in such cold weather to rapidly bring the engine 104 to the operational temperature. The engine warm-up system 202 is provided in connection with and as a part of the engine cooling system 202.

In the illustrated embodiment of the present disclosure, the engine warm-up system 202 includes a coolant heater 218 provided upstream of the coolant pump 206 in the inlet conduit 216 of the engine cooling system 200. The coolant heater 218 is configured to heat the coolant flowing around the engine 104, during cold environmental conditions. For example, the coolant heater 218 may be an electrical immersion heater including a heating coil 220 coiled around the inlet conduit 216. However, it may be contemplated that the coolant heater 218 may also be any other known electrical immersion heater that could be used to heat the coolant.

In an embodiment of the present disclosure, the coolant heater 218 is configured to be electrically powered by the auxiliary alternator 112 of the machine 100. The auxiliary alternator 112 is configured to power the coolant heater 218 when the engine 104 operates at low loads or idle conditions. For example, in cold weather conditions, when the engine 104 is started and operated at idle conditions or low load conditions, the auxiliary alternator 112 may be driven to electrically power the coolant heater 218 to heat the coolant flowing around the engine 104.

According to an embodiment of the present disclosure, the engine warm-up system 202 includes a thermostatic device 222 operably coupled to the coolant heater 218 and configured to control, operation of the coolant heater 218 based on a temperature of the coolant flowing through the coolant passage 204 and the cooling system 200. For example, the thermostatic device 222 is a thermostatic electrical switch which monitors the temperature of the coolant flowing inside the coolant passages 204 and the inlet conduit 216 and activates and/or deactivates the coolant heater 218 in response to a variation of the measured temperature of the coolant with respect to a reference temperature value. In the activated state, the coolant heater 218 is configured to draw electrical power from the auxiliary alternator 112.

In an exemplary embodiment of the present disclosure, the thermostatic device 222 may have a predefined reference temperature value T1 and may be configured to activate the coolant heater 218 when a temperature of the coolant T flowing around the engine 104 is less than the predefined reference temperature T1. Further, the thermostatic device 222 is configured to deactivate the coolant heater 218 when the temperature T of the coolant flowing around the engine 104 is greater than the predefined reference temperature value T1. In one example, the predefined reference temperature value T1 is 120 degrees Fahrenheit. It may be contemplated that the first predefined reference temperature value T1 may be set according to a desired operating temperature of the engine 104, therefore, the engine 104 is capable of operating machine 100 as soon as coolant flowing around the engine 104 reaches a temperature greater than the first predefined reference temperature value T1. Consequently, the coolant heater 218 is no more required for heating up the engine 104. It may be contemplated that the desired operating temperature of the engine 104 may be based on one or more engine related parameters, such as engine emissions, coolant temperature, oil temperature etc.

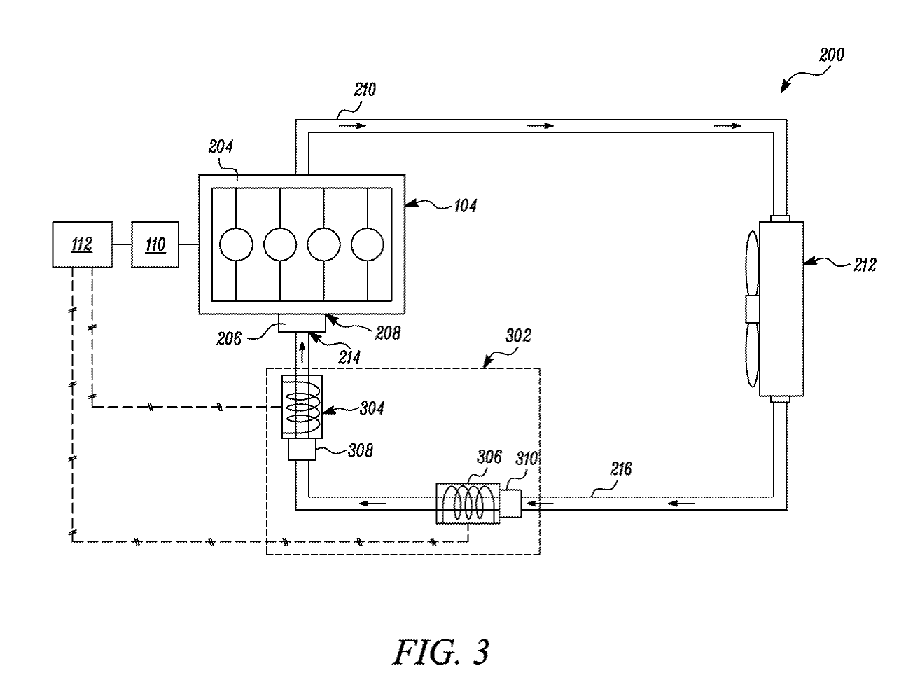

In another embodiment of the present disclosure, the engine warm-up system. 202 may include multiple coolant heaters which may be controlled by their respective thermostatic devices according to different predefined reference temperature values set for each of the thermostatic devices. In this embodiment as well, each of the coolant heaters are electrically powered by the auxiliary alternator 112 of the machine 100. Referring to FIG. 3, an engine warm-up system 302 is illustrated having two coolant heaters, such as a first coolant heater 304 and a second coolant heater 306 and corresponding thermostatic devices, such as a first thermostatic device 308 and a second thermostatic device 310.

In this embodiment, the first coolant heater 304 may be first activated by the first thermostatic device 308 when the coolant temperature is less than a first predefined reference temperature value T1. Further, when the temperature of the coolant flowing around the engine 104 continues to fall down or when the heat provided to the coolant is not adequate such that the coolant temperature T falls below a second predefined reference temperature value T2, then the second coolant heater 306 may be activated by the second thermostatic device 310. It may be well understood by a person skilled in the art that the second predefined reference temperature value T2 is less than the first predefined reference temperature value T1. In this embodiment, the first predefined reference temperature value T1 is 120 degrees Fahrenheit and the second predefined reference temperature value T2 is 110 degrees Fahrenheit.

Consequently, when both the coolant heaters 304, 306 are switched on, thereby producing more heat for heating the coolant, as soon as the temperature T of the coolant is greater than the second predefined reference temperature value T2, the second coolant heater 306 is deactivated by the second thermostatic device 310. Similarly, as soon as the temperature of the coolant T becomes greater than the first predefined reference temperature value T1, the first coolant heater 304 is deactivated by the first thermostatic device 308. As explained previously, the engine 104 reaches the operational temperature to operate the machine 100 when the coolant flowing around the engine 104 reaches above the first predefined reference temperature value T1.

### INDUSTRIAL APPLICABILITY

In cold weathers, when the engine 104 is started, it usually takes significant amount of time to reach a minimum operational temperature. The minimum operational temperature of the engine may be based on a number of engine related parameters, such as engine emissions, coolant temperature, oil temperature, etc. Till the time the engine 104 reaches the minimum operational temperature, the engine 104 is operated at idle conditions or at low load conditions, to gradually heat and bring the engine 104 up to the minimum operational temperature. In order to quickly bring the engine 104 up to the mini mm operational temperature, the engine warm-up system 202 of the present disclosure is used to heat the coolant flowing around the engine 104 in the coolant passages 204. Additionally, the engine warm up system 202 may provide heating to the other components of the engine system, the aftercooler components etc. during the cold weather. For example, the engine warm up system 202 may provide heat to the engine oil through the engine oil cooler for decreased engine wear and increased efficiency of the engine during cold weather. Similarly, the engine warm up system 202 may provide heating to the fuel in the fuel cooler or a fuel pre-heater (not shown) to prevent fuel freezing during extremely cold weather. Furthermore, the engine warm-up system 202 may heat the intake air through the engine aftercooler and the diesel exhaust fluid in the selective catalytic reduction system (SCR) (not shown) employed in the engine 104.

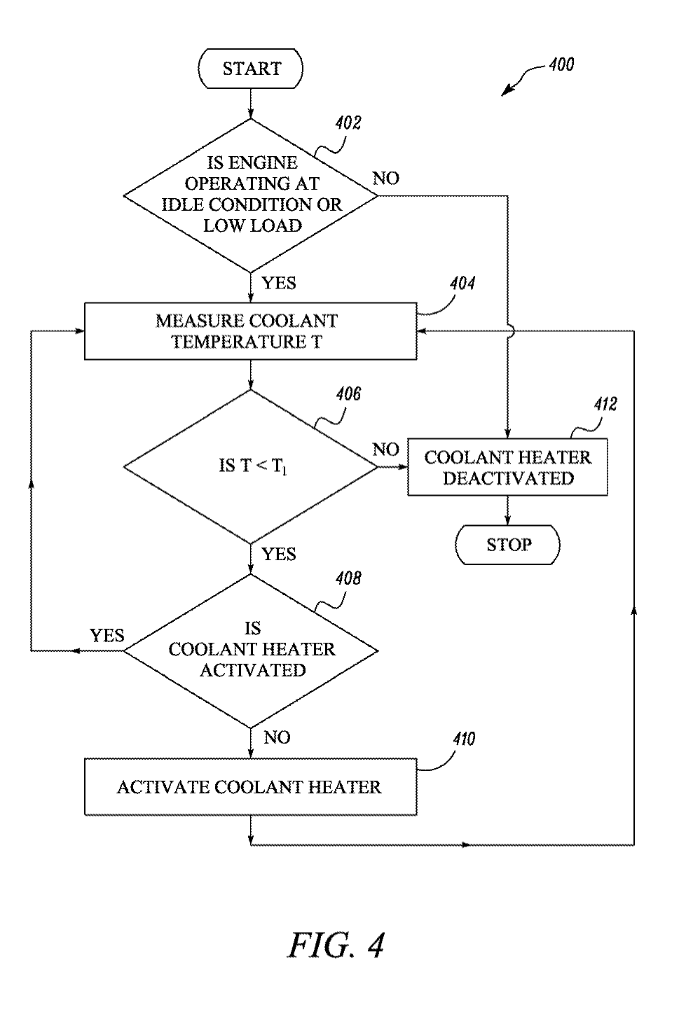

FIG. 4 illustrates an exemplary method for warming up the engine 104 of the machine 100, such as the locomotive 102. As explained previously, the machine 100 has a primary alternator 110 for powering the traction devices 114 and the auxiliary alternator 112 for powering auxiliary loads of the machine 100.

At step 402, it is determined if the engine 104 is running at idle conditions or low load conditions. In an exemplary embodiment, engine speed may be used to determine whether the engine 104 is operating at idle or low load conditions. For example, a machine controller (not shown) may determine the engine speed and the operating condition of the engine 104. If yes, then the method proceeds to step 404, where the temperature of the coolant T flowing in the coolant passages 204 around the engine 104 is determined. In an exemplary embodiment, the thermostatic device 222 associated with the coolant heater 218 is configured to measure the coolant temperature T. However, if the engine 104 is not running on idle conditions or low load conditions, then the coolant heater 218 is not required to provide additional heating to the engine 104, and therefore, the method proceeds to step 412 directly and the coolant heater 218 is deactivated.

Further, at step 406, if it is determined that the measured coolant temperature T is less than the predefined reference temperature value T1, then the method proceeds to check if the coolant heater 218 is already activated or not, at step 408. If the coolant heater 218 is already activated then the method continues to measure the temperature of the coolant T at step 404. In an embodiment of the present disclosure, the predefined reference temperature value T1 is set according to the desired minimum operational temperature of the engine 104, such that, when the coolant temperature T is greater than the predefined reference temperature value T1, the engine 104 has reached the minimum operational temperature to operate the machine 100.

However, if at step 406 it is determined that the measured coolant temperature T is less than the predefined reference temperature value T1 and the coolant heater 218 is not already activated, then the thermostatic device 222 activates the coolant heater 218, at step 410. In n an embodiment of the present disclosure, the coolant heater 218, when in the activated state, draws electrical power from the auxiliary alternator 112.

The method then repeats to continue measuring the temperature of the coolant T flowing around the engine 104, at step 404. The measured temperature of the coolant T is again checked to be less than the predefined reference temperature value T, at step 406.

However, if at step 406, it is determined that the measured coolant temperature T is not less than the predefined reference temperature value T1, then the method proceeds to step 412 where the thermostatic device 222 deactivates the coolant heater 218. This means, as soon as the coolant temperature T is determined to be equal to or greater than the predefined reference temperature value T1, then the engine 104 has reached the minimum operational temperature to operate the machine 100 and does not require additional heating by the coolant heater 218. Thus, the coolant heater 218 is deactivated and the method ends.

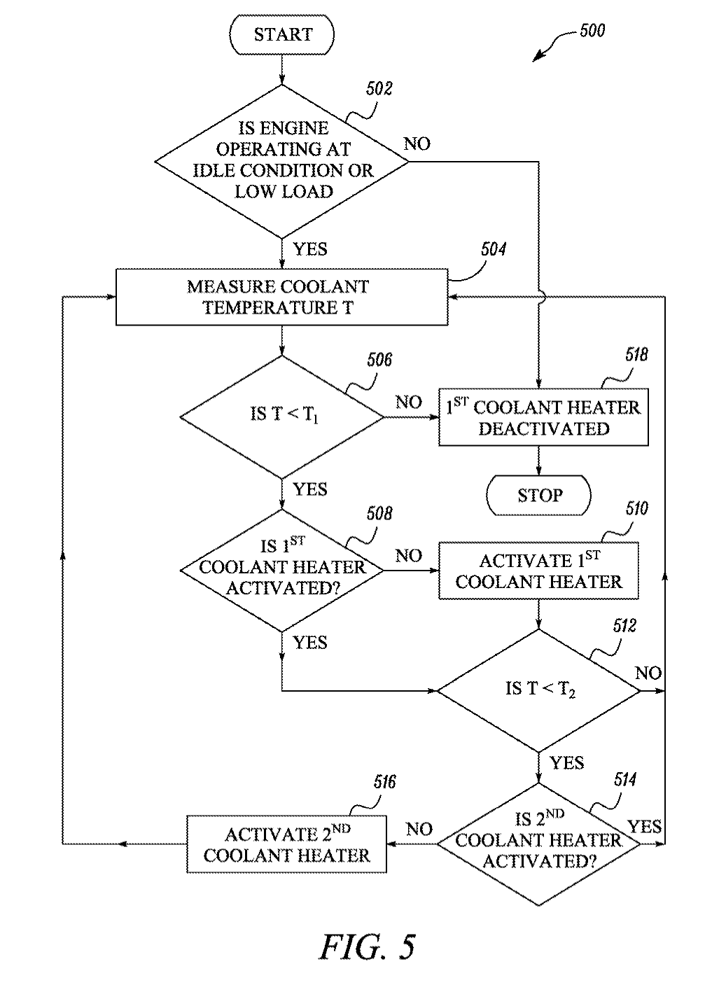

FIG. 5 illustrates another method for warming up the engine 104 of the machine 100, according to an alternative embodiment of the present disclosure. In the alternative embodiment, the engine warm-up system 302 of the machine 100 includes two or more coolant heaters 304, 306, as shown in FIG. 3.

At step 502, it is determined if the engine 104 is running at idle conditions or low load conditions. If yes, then the method proceeds to step 504, where the temperature of the coolant T flowing in the coolant passages 204 around the engine 104 is determined. In an exemplary embodiment, the thermostatic devices, such as the first thermostatic device 308 and the second thermostatic device 310 associated with the first coolant heater 304 and the second coolant heater 306, respectively, are configured to measure the coolant temperature T. However, if the engine 104 is not running on idle conditions or low load conditions, then the coolant heaters 304, 306 are not required to provide additional heating to the engine 104, and therefore, the method proceeds to step 518 directly and the first coolant heater 304 is deactivated.

Further, at step 506, if it is determined that the measured coolant temperature T is less than the first predefined reference temperature value T1, then the method proceeds to check if the first coolant heater 304 is already activated or not, at step 508. If the first coolant heater 304 is not already activated, then the first thermostatic device 308 activates the first coolant heater 304. In an embodiment of the present disclosure, the first predefined reference temperature value T1 is set according to the desired minimum operational temperature of the engine 104, such that, when the coolant temperature T is greater than the first predefined reference temperature value T1, the engine 104 has reached the minimum operational temperature to operate the machine 100. In an embodiment of the present disclosure, the first coolant heater 304, when in the activated state, draws electrical power from the auxiliary alternator 112.

However, if at step 506, it is determined that the measured coolant temperature T is less than the first predefined reference temperature value T1 and at step 508 it is determined that the first coolant heater 304 is already activated, then the method proceeds to step 512. At step 512, it is determined whether the measured coolant temperature T is less than a second predefined reference temperature value T2 or not. If at step 512, it is determined that the measured coolant temperature T is not less than the second predefined reference temperature value T2, then the method continues to step measure the temperature of the coolant T at step 504.

However, if at step 512, it is determined that the measured coolant temperature T is less than a second predefined reference temperature value T2, then the method proceeds to check if the second coolant heater 306 is already activated or not, at step 514. If at step 514, it is determined that the second coolant heater 306 is not already activated, then at step 516, the second coolant heater 306 is activated by the second thermostatic device 310. Similar to the first coolant heater 304, the second coolant heater 306, when in the activated state, also draws electrical power from the auxiliary alternator 112 of the machine 100.

However, if at step 514, it is determined that the second coolant heater 306 is already activated, then the method continues to measure the coolant temperature T at step 504. The measured temperature of the coolant T is again checked to be less than the first predefined reference temperature value T1, at step 506.

If at step 506, it is determined that the measured coolant temperature T is not less than the predefined reference temperature value T1, then the method proceeds to step 518 where the first thermostatic device 308 deactivates the first coolant heater 304. This means, as soon as the coolant temperature T is determined to be equal to or greater than the first predefined reference temperature value T1, then the engine 104 has reached the minimum operational temperature to operate the machine 100 and does not require additional heating by the coolant heaters 304, 306. Thus, the first coolant heater 304 is deactivated and the method ends. It may be contemplated that the second coolant heater 306 would only activate when the measured temperature of the coolant T goes below the second predefined reference temperature value T2, else, in all other conditions when the coolant temperature T is less than the first predefined reference temperature value T1 and greater than the second predefined reference temperature value T2, the second coolant heater 306 would remain deactivated. Thus, the method ends on deactivation of the first coolant heater 304.

The engine warm-up system 202, 302 of the present disclosure, are powered by the auxiliary alternator 112 of the machine 100 and do not require any external power source. Typically, when the engine 104 runs in idle conditions or low load conditions, in cold weather, the power generated by the auxiliary alternator 112 may not be consumed by the power consumption devices 116. Therefore, this power is utilized to power the coolant heaters 218, 304, and 306 to heat the coolant and bring the engine 104 up to the minimum operating temperature. In an embodiment of the present disclosure, the electrical power provided to the coolant heaters 218, 304, and 306 from the auxiliary alternator 112 is self-regulated. This means, that as the heated coolant (by the coolant heaters 218, 304, 306) is circulated around the engine 104, the engine speed increases, thereby resulting in more power being generated by the auxiliary alternator 112, and hence more power to the coolant heaters 218, 304, and 306. Consequently, the coolant heaters 218, 304, and 306 produce more heat. Meanwhile, the engine 104 also generates more heat when operating at higher speed which heats up the coolant even faster. The engine warm-up system 202 and 302 therefore facilitates quick heating up of the engine 104 in cold weather conditions to bring the engine 104 up to the optimum operational temperature to operate the machine 100 in such cold weather.

While aspects of the present disclosure have been particularly depicted and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

1. A warm up system for an engine of a machine having a primary alternator driven by the engine and an auxiliary alternator driven by the primary alternator and configured to power one or more auxiliary loads of the machine, the warm up system comprising:
a first coolant heater configured to heat a coolant flowing through one or more coolant passages of the engine, the first coolant heater being electrically powered by the auxiliary alternator of the machine when the engine operates in low load or idle conditions;
a first thermostatic device operably coupled to the first coolant heater and configured to control operation of the first coolant heater based on a temperature of the coolant flowing through the one or more coolant passages;
a second coolant heater configured to heat the coolant flowing through the one or more coolant passages of the engine, the second coolant heater being electrically powered by the auxiliary alternator of the machine when the engine operates in low load or idle conditions; and
a second thermostatic device operably coupled to the second coolant heater and configured to control operation of the second coolant heater based on the temperature of the coolant flowing through the one or more coolant passages,
wherein the first thermostatic device is configured to control the first coolant heater based on a first predetermined reference temperature value, and wherein the second thermostatic device is configured to control the second coolant heater based on a second predetermined reference temperature value different from the first predetermined reference temperature value.

2. (canceled)

3. The engine warm up system of claim 1, wherein the first thermostatic device is configured to activate the first coolant heater to heat the coolant flowing through the one or more coolant passages of the engine, when the temperature of the coolant is less than the first predefined reference temperature value.

4. The engine warm system of claim 1, wherein the first thermostatic device is configured to deactivate the first coolant heater when the temperature of the coolant is greater than the first predefined reference temperature value.

5. The engine warm up system of claim 1, wherein the first thermostatic device is configured to control operation of the first coolant heater based on the temperature of the coolant varying with respect to the first predefined reference temperature value, the first predefined reference temperature value being 120 degrees Fahrenheit.

6. The engine warm up system of claim 1, wherein the is configured to activate the second coolant heater to heat the coolant flowing through the one or more coolant passages of the engine when the temperature of the coolant is less than the second predefined reference temperature value.

7. The engine warm up system of claim 6, wherein the second thermostatic device is configured to deactivate the second coolant heater when the temperature of the coolant is greater than the second predefined reference temperature value.

8. The engine warm up system of claim 7, wherein the second predefined reference temperature value is 110 degrees Fahrenheit.

9. A method for warming up an engine of a machine having a primary alternator and an auxiliary alternator, the method comprising:
measuring a temperature of a coolant flowing through one or more coolant passages of the engine; and
operating at least one coolant heater to heat the coolant flowing through the one or more coolant passages of the engine based on the measured temperature of the coolant, wherein the at least one coolant heater is electrically powered by the auxiliary alternator of the machine when the engine operates in low load or idle conditions,
wherein the steps of measuring the temperature of the coolant flowing through the one or more coolant passages of the engine and operating the at least one coolant heater to heat the coolant are performed in response to an engine start operation or detecting that the engine is running at idle or low load conditions.

10. The method of claim 9, wherein the auxiliary alternator is configured to power one or more auxiliary loads of the machine; and
wherein the auxiliary alternator powers the at least one coolant heater during the engine start operation.

11. The method of claim 9, wherein operating the at least one coolant heater further comprises activating the at least one coolant heater to heat the coolant flowing through the one or more coolant passages of the engine when the measured temperature of the coolant is less than a first predefined reference temperature value.

12. The method of claim 9, wherein operating the at least one coolant heater further comprises deactivating the at least one coolant heater when the measured temperature of the coolant is greater than the first predefined reference temperature value.

13. The method of claim 9, wherein operating the at least one coolant heater further comprises operating the at least one coolant heater based on the temperature varying with respect to a first predefined reference temperature value, the first predefined reference temperature value being 120 degrees Fahrenheit.

14. The method of claim 9, further including activating a second coolant heater to heat the coolant flowing through the one or more coolant passages of the engine when the measured coolant temperature is less than a second predefined reference temperature value.

15. The method of claim 14, further comprising deactivating the second coolant heater when the measured coolant temperature is greater than the second predefined reference temperature value.

16. The method of claim 15, wherein the second predefined reference temperature value is 110 degrees Fahrenheit.

17. A machine comprising:
an engine having one or more coolant passages defined therein;
a primary alternator driven by the engine and configured to power large loads of the machine;
an auxiliary alternator driven by the primary alternator and configured to power auxiliary loads of the machine;
an engine cooling system configured to circulate a coolant through the one or more coolant passages of the engine;
at least one coolant heater operably connected to the engine cooling system and configured to heat a coolant flowing through the one or more coolant passages of the engine, the at least one coolant heater being electrically powered by the auxiliary alternator of the machine when the engine operates in low load or idle conditions; and
a thermostatic device operably coupled to the engine cooling system and the at least one coolant heater, the thermostatic device being configured to operate the at least one coolant heater to heat the coolant flowing through the one or more coolant passages of the engine based on a temperature of the coolant flowing through the one or more coolant passages.

18. The machine of claim 17, wherein the thermostatic device is configured to activate the at least one coolant heater to heat the coolant flowing through the one or more coolant passages of the engine when the temperature of the coolant is less than a first predefined reference temperature value.

19. The machine of claim 17, wherein the at least one coolant heater is a first coolant heater and the thermostatic device is a first thermostatic device, the machine further comprising a second coolant heater and a second thermostatic device operably coupled to the second coolant heater and configured to activate the second coolant heater to heat the coolant flowing through the one or more coolant passages of the engine when the temperature of the coolant is less than a second predefined reference temperature value.

20. The engine warm up system of claim 1, wherein the first thermostatic device is configured to activate the first coolant heater to heat the coolant flowing through the one or more coolant passages of the engine when the temperature of the coolant is less than 120 degrees Fahrenheit, and wherein the first thermostatic device is configured to deactivate the first coolant heater when the temperature of the coolant is greater than 120 degrees Fahrenheit; and
wherein the second thermostatic device is configured to activate the second coolant heater to heat the coolant flowing through the one or more coolant passages of the engine when the temperature of the coolant is less than 110 degrees Fahrenheit, and wherein the second thermostatic device is configured to deactivate the second coolant heater when the temperature of the coolant is greater than 110 degrees Fahrenheit.

21. The machine of claim 17, wherein the thermostatic device is a first thermostatic device;
wherein the at least one coolant heater includes a first coolant heater;
wherein the first thermostatic device is configured to activate the first coolant heater to heat the coolant flowing through the one or more coolant passages of the engine when the temperature of the coolant is less than 120 degrees Fahrenheit, and wherein the first thermostatic device is configured to deactivate the first coolant heater when the temperature of the coolant is greater than 120 degrees Fahrenheit; and
wherein a second thermostatic device is configured to activate a second coolant heater to heat the coolant flowing through the one or more coolant passages of the engine when the temperature of the coolant is less than 110 degrees Fahrenheit, and wherein the second thermostatic device is configured to deactivate the second coolant heater when the temperature of the coolant is greater than 110 degrees Fahrenheit.
